(19) United States
(12) Patent Application Publication
(10) Pub. No.: US 2023/0369715 A1
(43) Pub. Date: Nov. 16, 2023

(54) ELECTRIC BATTERY FOR AN ELECTRIC VEHICLE

(71) Applicant: VOLTABOX AG, Delbrück (DE)

(72) Inventors: Juergen PAMPEL, Vlotho (DE); Constantin WERTH, Paderborn (DE); Martin HELMES, Delbrueck (DE)

(21) Appl. No.: 18/027,018

(22) PCT Filed: Nov. 30, 2020
(86) PCT No.: PCT/EP2020/000206

§ 371 Date: Mar. 17, 2023

(30) Foreign Application Priority Data
Sep. 25, 2020 (DE) 10 2020 005 872.8

(51) Int. Cl. H01M 50/383; H01M 50/222; H01M 50/264; H01M 50/209; H01M 50/227

(52) U.S. Cl. CPC H01M 50/383; H01M 50/222; H01M 50/264; H01M 50/209; H01M 50/227; H01M 2220/20; H01M 2220/10

(57) ABSTRACT

An electric battery (1) for an electrically or partially electrically driven motor vehicle, movable or stationary unit has a battery housing (5) and a plurality of battery cells (2) arranged therein. According to the invention, the battery housing (5) is made from a material containing silicon and/or calcium and/or rubber and/or silicone to produce such an electric battery (1) with a minimum of economic and technical design effort while ensuring said battery is still highly operationally reliable.

The invention relates to an electric battery for an electrically or partially electrically driven motor vehicle or a movable or stationary unit, comprising a battery housing and a plurality of battery cells therein.

In order to be able to make an electric battery of this type that usually forms a core component of an electrically or partially electrically driven motor vehicle or of a movable unit, and that can be an essential part of a stationary unit, with as little economic and technically structural effort as possible, it is proposed according to the invention that the battery housing of the electric battery is made or formed of a material containing silicon and/or calcium and/or rubber and/or silicone. The electrical interconnection of the battery cells can take place before or after the introduction of the battery cells into the battery housing. Due to its design of the material containing silicon and/or calcium and/or rubber and/or silicone, the battery housing, compared to battery housings of this type that are known from the prior art, is suitable to absorb significantly higher mechanical energy amounts. Due to the design according to the invention of the battery housing of the material containing silicon and/or calcium and/or rubber and/or silicone, the assembly of the electric battery is furthermore significantly simplified. The production of the battery housing and thus of the electric battery can be automated to a large extent, whereby the economic effort can be reduced significantly. The material properties of the material containing silicon and/or calcium and/or rubber and/or silicone, ensure a thermal insulation of the electric battery in particular in cold environments. In the event of a so-called thermal runaway, the electric battery designed according to the invention ensures a high safety due to the slight resistance of the battery housing. Possible pressure build-up can be released directly into the environment. The electric battery can be assembled quasi in any installation position. Due to its absorbability for static and dynamic loads, the battery housing designed according to the invention ensures a high resistance against impacts, shocks, and vibrations.

According to an advantageous design of the electric battery according to the invention the battery housing is made entirely of silicon and/or calcium and/or rubber and/or silicone.

The battery cells of the electric battery according to the invention can have any shapes; they can be formed, e.g. as round cell, as prismatic cell, or as pouch cell.

Instead of the battery housing or in addition to the battery housing, a holder can be provided for the battery cells and further battery components, e.g. sensor parts that is likewise made of an expanded or foamed plastic and/or the material containing silicon and/or calcium and/or rubber and/or silicone and/or made entirely of silicon and/or calcium and/or rubber and/or silicone.

The battery housing as well as the holder that is optionally provided instead of the battery housing or in addition to the battery housing, can be of multi-piece construction.

Towards the upper face, the battery housing can advantageously be closed by a cover that is likewise made of the material of the battery housing.

The plus and minus poles of the battery cells are expediently guided to the outer side of the battery housing.

The same applies for further electrical interfaces, electronic interfaces, mechanical interfaces and/or thermal interfaces.

According to an advantageous design of the electric battery according to the invention, the battery housing thereof is made of the material containing silicon and/or calcium and/or rubber and/or silicone and/or made entirely of silicon and/or calcium and/or rubber and/or silicone covering and surrounding a battery-cell pack formed of the plurality of the battery cells of the electric battery.

The battery-cell pack that is formed of the battery cells, is advantageously joined together or fixed, by a belt surrounding the battery cells, before it is introduced into the battery housing or before the battery housing is made around the battery-cell pack.

Preferably the belt is a fibre-reinforced adhesive tape or mesh.

Alternatively, it is possible to join together the battery cells to form the battery-cell pack by their electric cell connectors that serve for the electrical connection to each other.

Each temporary fixing device can generally be provided in order to fix the battery-cell pack.

Passages that can serve, e.g. as cooling, stiffening and/or reinforcing passages, can be provided in the entire body forming the battery housing.

When the battery housing of the electric battery has shapes formed on its outer side that can join together a number of electric batteries of this type or battery housings, into a stack, electric batteries of this type can be joined together in a simple way to form larger battery assemblies.

To ensure battery assemblies of this type that have a plurality of electric batteries, it is advantageous when the battery housings have a latch on their outer sides can latch a plurality of electric batteries of this type or battery housings, with one another or to one another.

When the material forming the battery housing has a high gas content, the battery housing can be designed in extreme lightweight construction.

According to an advantageous embodiment of the electric battery according to the invention, the material of the battery housing contains a flame-retardant, preferably self-extinguishing, energy absorbing and smoke gas pollutant binding material.

The battery housing advantageously has at least one reservoir or at least one cavity, in which substances and components, e.g. extinguishing substances, PyroBubbles or similar stuffs, can be stored. An increased safety can be provided thereby, whereby the dampening effect of the battery housing can furthermore be increased.

As further safety measure, it is possible to surround the battery housing or battery-cell pack of the electric battery with a safety shell, wherein safety elements can furthermore be introduced into one or several cavities that are formed by the battery housing or battery-cell pack.

Depending on the requirement profile, the battery housing can be designed arbitrarily with respect to its geometry, its outer surface, and its dimensions.

If the battery housing or the holder is made of a material containing silicon or silicon it is advantageous to use a silicon that is a two-component silicon.

A particularly suitable silicon material is TFC silicon-rubber type 3.

Appropriately the silicon contains as a base silicon type A and as a catalyst silicon type B.

In the case of a method according to the invention for making and assembling an electric battery for an electrically or partially electrically driven motor vehicle, movable or stationary unit, a plurality of battery cells is arranged in a battery housing, wherein the battery housing made of the material containing silicon and/or calcium and/or rubber and/or silicone and/or entirely of silicon and/or calcium and/or rubber and/or silicone that covers and entirely surrounds the battery structure and is cured there.

During being covered by and curing of the battery housing, the battery-cell pack can advantageously be fixed by a belt, an adhesive tape or a mesh that surrounds this battery-cell pack.

Alternatively, the battery-cell pack can be fixed by electric cell connectors during being covered by and curing of the battery housing.

Alternatively or additionally, a temporary fixing device for the purpose of fixing the battery-cell pack can be provided during being covered by and curing of the battery housing.

It is generally also possible to mount the battery-cell pack in fixed form in an installation space of the motor vehicle or of the unit, and to provide it with the battery housing there.

The invention is described in more detail below with reference to embodiments shown in a drawing in which:

FIG. 1 is a perspective view of a group of battery cells of an embodiment of an electric battery according to the invention;

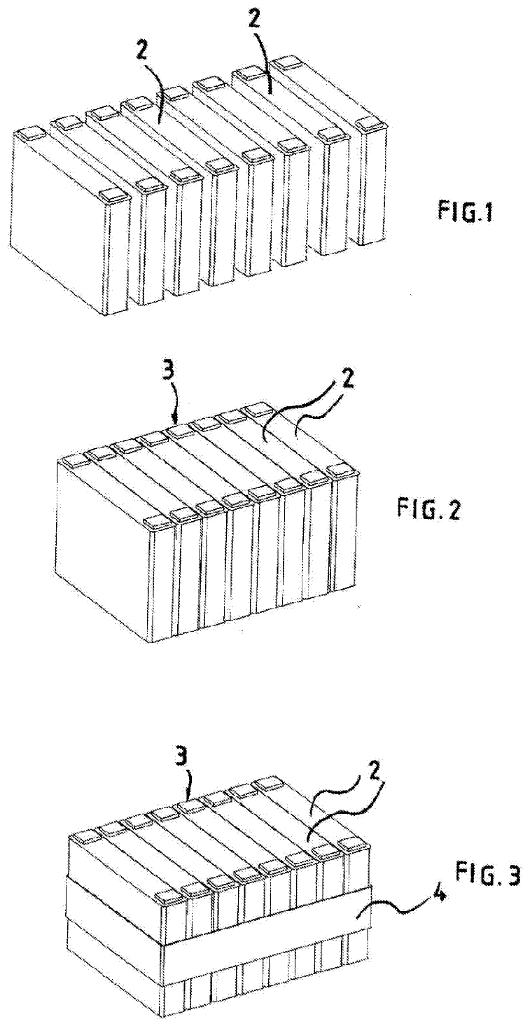

FIG. 2 is a perspective view of a battery-cell pack made up of the battery cells shown in FIG. 1;

FIG. 3 is the battery-cell pack shown in FIG. 2 with a belt surrounding it;

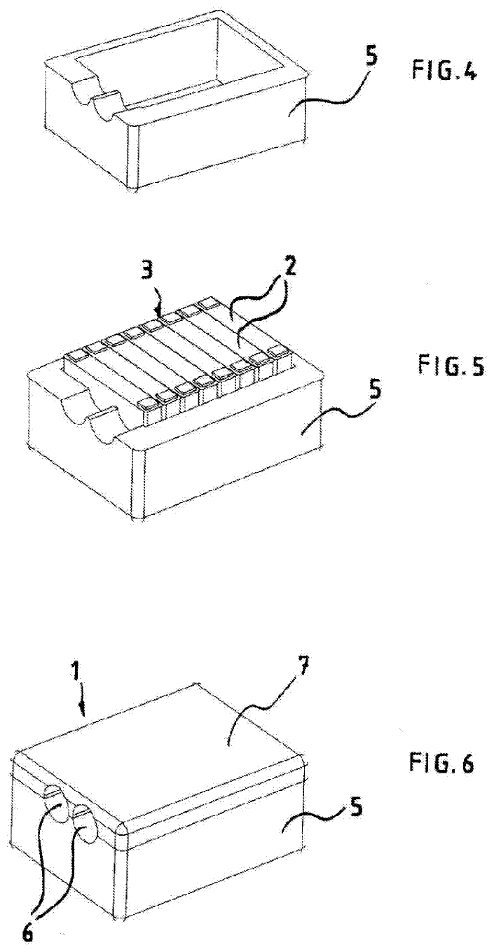

FIG. 4 is a perspective view of a battery housing of the electric battery according to the invention;

FIG. 5 is the battery housing shown in FIG. 4 holding the battery-cell pack shown in FIG. 2 or 3;

FIG. 6 is a perspective view of the battery housing shown in FIGS. 4 and 5 with a cover;

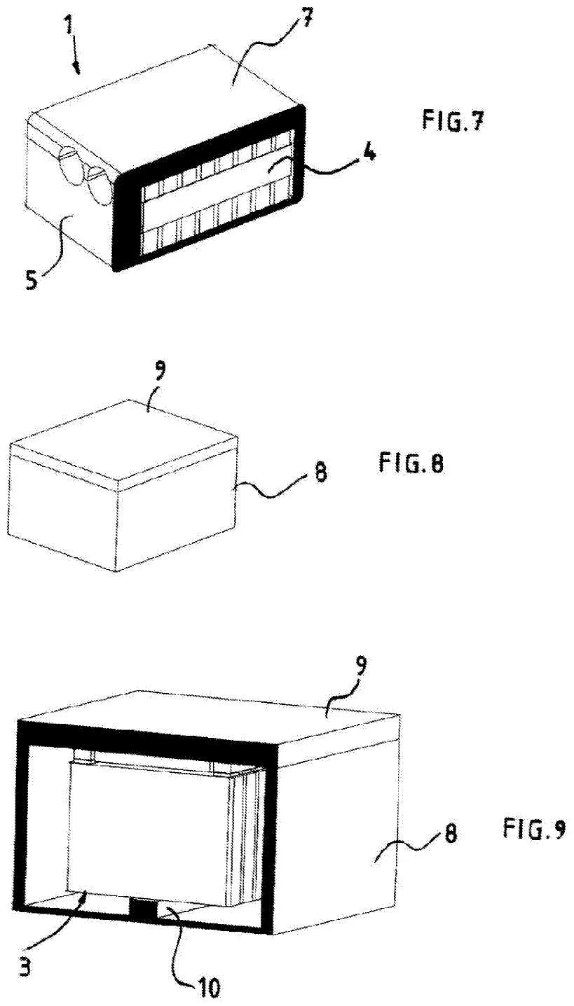

FIG. 7 is a perspective view of the battery housing shown in FIG. 6 with a cover, a side wall of the battery housing being cut away in order to show the battery-cell pack inside the battery housing;

FIG. 8 is a housing shell including cover for receiving the battery-cell pack that is to be provided with a battery housing;

FIG. 9 is a perspective view of the battery-cell pack in the housing shell shown in FIG. 8;

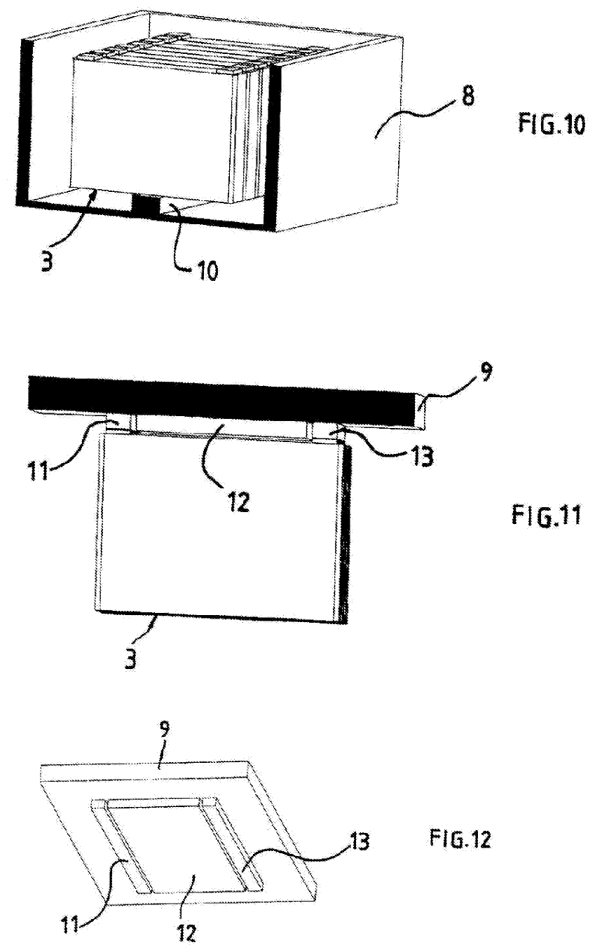

FIG. 10 is a view corresponding to FIG. 9, where the cover of the housing shell is omitted;

FIG. 11 is a view of the battery-cell pack comprising a cover assigned to the housing shell; and

FIG. 12 is a perspective view of the cover shown in FIG. 11 that is assigned to the housing shell.

An electric battery 1 that will be described in more detail below on the basis of embodiments shown in the drawing, for an electrically or partially electrically driven motor vehicle or for a movable or a stationary unit has battery cells 2 shown in FIG. 1. The number of the battery cells 2 is arbitrary. Eight battery cells 2 are illustrated in FIG. 1 that belong to the embodiment of the electric battery 1 that will be described in more detail below.

The battery cells 2 are joined together to form a battery-cell pack 3, as shown in FIG. 2.

It is important to point out that with respect to the shape of the battery cells 2, other prismatic cells than those shown in FIG. 2 are also possible, e.g. round cells or pouch cells.

In the illustrated embodiment, the battery cells 2 that are joined together to form the battery-cell pack 3 are fastened to one another by a belt 4 surrounding the battery-cell pack 3, as follows in particular from FIG. 3.

Instead of a fastening of the battery-cell pack 3 by the belt 4, technical solutions are also possible in which the solid battery-cell pack 3 is realized by cell connectors that are not illustrated in the drawing, or in which a temporary fixing device is provided.

The battery-cell pack 3 shown in FIGS. 2 and 3 is in a battery housing 5, as shown by way of example in FIG. 4. The battery housing 5 is made of a material containing silicon and/or calcium and/or rubber and/or silicone or entirely of silicon and/or calcium and/or rubber and/or silicone. The battery-cell pack 3 is shown in the battery housing 5 in FIG. 5. The poles of the battery-cell pack 3 in the battery housing 5 are accessible through connecting passages 6 provided on the housing. Connection of further electrical interfaces, electronic interfaces, mechanical interfaces and/or thermal interfaces can thereby also extend through the battery housing 5 to the exterior. On its upper face, the battery housing 5 can be closed by a cover 7, as shown in FIG. 6. The cover 7 is here made of the same material as the remaining battery housing 5.

Instead of the battery housing 5 or in addition to the battery housing 5, a holder can be provided that serves the purpose of hold the battery cells 2 as well as further battery components, such as sensor parts, etc. A holder of this type is not shown in the drawing and can also be made of the material containing silicon and/or calcium and/or rubber and/or silicone or entirely of silicon and/or calcium and/or rubber and/or silicone.

The silicon can be a two-component silicon, preferably a TFC silicon-rubber type 3. The silicon can contain as a base silicon type A and as a catalyst silicon type B.

The battery housing 5 on which the cover 7 fits and this holder, insofar as the above-mentioned holder is provided, can be of multi piece construction.

FIG. 7 shows the electric battery shown in FIG. 6 with a side wall omitted in order to show how the battery-cell pack including the belt 4 are received by the battery housing 5 and the cover 7.

The battery housing 5 can have further passages that are not shown in the drawing that can be formed as cooling, stiffening and/or reinforcing passages.

In the case of a further embodiment of the electric battery according to the invention, a production process is provided in which, e.g. the housing shell 8 shown in FIG. 8 is used, to which a cover casing 9 belongs. The battery-cell pack 3 is introduced into the assembly of the housing shell 8 and cover casing 9.

In the embodiment shown in FIGS. 9 and 10, the battery-cell pack 3 rests on a support 10 that is part of the housing shell 8.

The cover casing 9 shown in FIG. 12 has casing parts 11, 12, 13 that project toward the battery-cell pack 3 lie between the actual cover casing 9 and the upper face of the battery-cell pack 3, as follows best from FIG. 11. The material forming the battery housing 5 is introduced into the space between the housing shell 8 and the cover casing 9 on the one hand, and the battery-cell pack 3 on the other hand, completely surrounds the battery-cell pack 3, and is cured. It goes without saying that further structural parts can be provided before the introduction and curing of the material of the battery housing 5, so the passages, hollow spaces, etc. that are required for the electric battery 1, can be formed.

It goes without saying that fixation of the battery-cell pack 3 in the assembly shown in FIGS. 9 and 10 can also take place with help of the belt 4, but can also be realized differently. On its outer surface, the battery housing 5 of the electric battery 1 can be designed arbitrarily. It can have its outer faces formations that can join a plurality of electric batteries 1 of this type together in a stack. Latching of the electric batteries 1 to their battery housings 5 is also conceivable.

The material forming the battery housing 5 as well as optionally the cover 7 can have a high gas content. The material of the battery housing 5 furthermore contains a flame-retardant or self-extinguishing, energy-absorbing and smoke/gas/pollutant-binding material. Reservoirs or cavities that are not illustrated in the FIGS. and in which substances, such as PyroBubbles, are stored, can be formed within the battery housing 5.

The battery housing 5 and/or the battery-cell pack 3 can be surrounded by a safety shell that is not illustrated in the drawing. Safety elements can furthermore be introduced into one or several cavities that are formed by the battery housing 5 or by the battery-cell pack 3.

A design of the electric battery 1 according to the invention is generally also possible, in which the battery-cell pack 3 of the electric battery 1 is inside the motor vehicle or another unit, at the installation site and is provided there with the battery housing 5, and the battery housing 5 is realized by introduction and curing of the material forming the battery housing 5.

1. An electric battery for an electrically or partially electrically driven motor vehicle or for a movable or stationary unit, the battery comprising:
a battery housing and
a plurality of battery cells therein, the battery housing is being made of a material containing silicon and/or calcium and/or rubber and/or silicone.

2-3. (canceled)

4. The electric battery according to claim 1, wherein the battery housing and/or a holder for the battery cells and further battery components, e.g. sensor parts, are made of an expanded or formed plastic and/or of the material containing silicon and/or calcium and/or rubber and/or silicone and/or entirely of silicon and/or calcium and/or rubber and/or silicone.

5-6. (canceled)

7. The electric battery according to claim 1, wherein plus and minus poles extend through the battery housing to the exterior.

8. The electric battery according to claim 7, wherein further electrical interfaces, electronic interfaces, mechanical interfaces and/or thermal interfaces extend through the battery housing to the exterior.

9. The electric battery according to claim 1, wherein the battery housing err is made of the material containing silicon and/or calcium and/or rubber and/or silicone and/or entirely of silicon and/or calcium and/or rubber and/or silicone covering and surrounding a battery-cell pack formed of the plurality of the battery cells of the electric battery.

10. The electric battery according to claim 9, wherein the battery cells are joined together by a belt into the battery-cell pack.

11. The electric battery according to claim 10, wherein the belt surrounding the battery-cell pack is a adhesive tape or mesh.

12. The electric battery according to claim 9, wherein the battery cells are joined together to form the battery-cell pack by electric cell connectors that serve for electrical connection to each other.

13. The electric battery according to claim 9, wherein the battery-cell pack can be secured by a temporary fixing device.

14. The electric battery according to claim 1, wherein the battery housing has passages that are formed as cooling, stiffening and/or reinforcing passages.

15. The electric battery according to claim 1, wherein the battery housing has shapes formed on its outer side that connect together a plurality of electric batteries of this type or battery housings into a stack.

16. The electric battery according to claim 1, wherein the battery housing has a latch on its outer side that secure a plurality of electric batteries of this type or battery housings together or to one another.

17. The electric battery according to claim 1, wherein the material of the battery housing has a high gas content and contains a flame-retardant, energy absorbing and smoke/gas/pollutant-binding material.

18-19. (canceled)

20. The electric battery according to claim 1, wherein the battery housing or the battery-cell pack is surrounded by a safety shell and/or safety elements are introduced into one or several cavities that are formed by the battery housing or battery-cell pack.

21. (canceled)

22. The electric battery according to claim 1, wherein the silicon is a two-component-silicon.

23. The electric battery according to claim 1, wherein the silicon is designed as TFC silicon-rubber type 3.

24. The electric battery according to claim 1, wherein the silicon contains as a base silicon type A and as a catalyst silicon type B.

25. A method of making and assembling an electric battery for an electrically or partially electrically driven motor vehicle or a movable or stationary unit in which a plurality of battery cells is provided in a battery housing err, wherein the battery housing is made of a material containing silicon and/or calcium and/or rubber and/or silicone and/or entirely of silicon and/or calcium and/or rubber and/or silicone, that covers and entirely surrounds the battery-cell pack and that is cured there.

26. The method according to claim 25, wherein the battery-cell pack is fixed during installation and curing of the battery housing by a belt by an adhesive tape or a mesh surrounding the battery-cell pack or is held by cell connectors during assembly and curing of the battery housing or is fixed by a temporary fixing device during installation and curing of the battery housing.

27-28. (canceled)

29. The method according to claim 25, wherein the battery-cell pack is used in an installation space of the motor vehicle or unit and is provided there with the battery housing.
